(19) United States
(12) Patent Application Publication
(10) Pub. No.: US 2012/0288342 A1
(43) Pub. Date: Nov. 15, 2012

(54) DEVICE FOR REWORKING THE RUNNING SURFACE OF A RAIL HEAD BY MACHINING

(76) Inventor: Helmut Rungger, Roitham (AT)

(21) Appl. No.: 13/574,310

(22) PCT Filed: Jan. 21, 2010
(86) PCT No.: PCT/AT2011/000037

§ 371 Date: Jul. 23, 2012

(30) Foreign Application Priority Data
Jan. 21, 2010 (AT) A 74/2010

(51) Int. Cl. B23C 1/00

(52) U.S. Cl. 409/231

(57) ABSTRACT

A device (1) is described for reworking the running surface (17) of a rail head (2) by machining having a framework (5) guided along the rail head (2), in which two machining tools, which are drivable to rotate in opposite directions and can frontally approach the running surface (17), are mounted on both sides of the rail head (2). In order to be able to provide advantageous machining conditions, it is proposed that the machining tools be designed as face millers (11), whose rotational axes (12) extend in a common plane (13) and whose cutting areas overlap one another transversely to the longitudinal direction of the rail head (2), and the two face millers (11) be connected via a transfer case (10) to a common rotational drive (9).

### FIELD OF THE INVENTION

The invention relates to a device for reworking the running surface of a rail head by machining having a framework guided along the rail head, in which two machining tools, which are drivable to rotate in opposite directions and can frontally approach the running surface, are mounted on both sides of the rail head.

### DESCRIPTION OF THE PRIOR ART

Because of comparatively high axial loads and high travel speeds, rails are often strained up to the yield point of the rail material and are therefore subject to wear, which has a disadvantageous effect on the profile of the running surface of the rail head, so that for maintenance of the rails, the running surfaces must be reworked. For this purpose, grinding assemblies are known (AT 344 772 B), which have at least two cup wheels, which are arranged in succession in the longitudinal direction of the rail head and approach the running surface frontally on opposite sides of the rail head, having a grinding profile corresponding to the running surface profile. In such grinding assemblies and also in other grinding assemblies (WO 2003/042458 A2), it is disadvantageous that in particular at higher advance speeds, substantial heating of the rail head must be expected, whereby the possible machining speed is restricted. To increase the machining speed, it has therefore been proposed (DE 32 22 208 A1) that milling tools be used, whose blades, which are distributed in multiple axial groups around the circumference of the cutter head, reproduce the rail head profile. However, the cutting curve of the individual blades of the milling tool, which is caused by such peripheral milling and is curved in a surface-normal longitudinal plane, results in a wavy surface of the rail head in the rail longitudinal direction, the surface quality worsening with increasing advance speed because of the increasing spacing of the chip removals of successive blades.

These disadvantages are avoided by face millers (U.S. Pat. No. 4,583,893), which are arranged on one side of a rail head and are used with a complex guide, which has a freely rotatably mounted guide disc and multiple guide rollers on the opposing rail side. In addition to the comparatively large design expenditure, the substantial functional disadvantage results that to machine the side of the rail head opposite to the face miller, a face miller must be used in a comparatively large spacing in the rail longitudinal direction, which results in uneven machining of the two sides of the rail head under certain circumstances.

Similar disadvantages result in the case of another known device (EP 0 148 089 A2), in which the running surface is machined on both sides of the longitudinal center by a milling head, which is designed as a face miller, but must be used having a correspondingly inclined axis, because peripheral millers for the longitudinal sides of the rail head must be arranged before or after this common milling head.

### SUMMARY OF THE INVENTION

The invention is therefore based on the object of implementing a device of the type described at the beginning for reworking the running surface of a rail head by machining in such a manner that advantageous running surface machining at a comparatively high processing speed can be ensured, without having to accept excess heat stress of the rail head.

The invention achieves the stated object in that the machining tools are designed as face millers, whose rotational axes extend in a common plane and whose cutting areas overlap one another transversely to the longitudinal direction of the rail head, and the two face millers are attached via a transfer case to a common rotational drive.

Through the arrangement of the rotational axes of the face millers, which are mounted in a common framework, in a common plane, the design specifications are provided for attaching these face millers via a transfer case to a common rotational drive, which not only decreases the design effort, but rather also provides the possibility of guiding the two face millers via the common framework along the rail to be machined in such a manner that uniform machining of the two rail head sides by the face millers, which are opposite to one another in relation to the rail head, is made possible. A requirement for this purpose is that the two face millers have at most a limited mutual spacing from one another in the longitudinal direction of the rail head, which is determined by the two intermeshing gear wheels of the transfer case for driving the shafts of the face millers. The rotational axes of the two face millers do not necessarily have to extend parallel to one another. A greater ablation of the running surfaces can be made possible with a correspondingly inclined approach of the face millers.

The most favorable machining conditions result if the two face millers have essentially no mutual offset in the longitudinal direction of the rail head. This can be achieved in that the face millers have radial attachments, which are distributed around the circumference and equipped with milling cutters, and which engage with radial spacing in the gaps between the staggered offset attachments of the respective opposing face miller. In this case, the rotational axes of the two face millers can also lie in a common plane perpendicular to the longitudinal direction of the rail head. Through these measures, due to the overlapping face millers, precise running surface machining, which is not impaired by a tool spacing in the longitudinal direction of the rail head, can be ensured by the face millers guided along the rail head. The overlapping cutting areas of the face millers, which are opposite to one another in relation to the rail head, is achieved by the radial attachments, which are distributed over the circumference and equipped with milling cutters, and which are offset staggered in relation to the radial attachments of the opposing face miller, so that if the face millers are driven synchronously in opposite directions, the milling cutters of the radial attachments of one face miller engage in the gaps resulting between the attachments of the opposing face miller.

In order to achieve milling machining of the rail head corresponding to the target profile of the running surface, the milling cutters of the face millers can have profile blades adapted to the cross-sectional curve of the running surface. Such reworking of the running surface corresponding precisely to the target curve is generally not required, however. In this case, the face millers can have at least two rings of milling cutters, which are radially offset to one another, having linear blades, which reproduce the cross-sectional curve of the running surface in the form of a traverse, the maximum deviation from the target profile being able to be influenced by the number of the milling cutter rings.

### BRIEF DESCRIPTION OF THE DRAWING

The object of the invention is shown as an example in the drawing. In the figures:

FIG. 1 shows a device according to the invention, provided on a rail vehicle, for reworking the running surface of a rail head by machining in a schematic side view,

FIG. 2 shows the framework guided along the rail head having the two machining tools in a schematic section, which is perpendicular to the longitudinal direction of the rail head, in an enlarged scale,

FIG. 3 shows the two face millers of the device according to the invention in detail in a bottom view in an enlarged scale,

FIG. 4 shows a view corresponding to FIG. 3 of an embodiment variant of the face millers,

FIG. 5 shows a section through a face miller corresponding to line V-V of FIG. 4 in an enlarged scale,

FIG. 6 shows a bottom view of the framework having the two face millers of a further design variant of a device according to the invention,

FIG. 7 shows a section along line VII-VII of FIG. 6, and

FIG. 8 shows a view corresponding to FIG. 6 of an additional design variant.

### DESCRIPTION OF THE PREFERRED EMBODIMENT

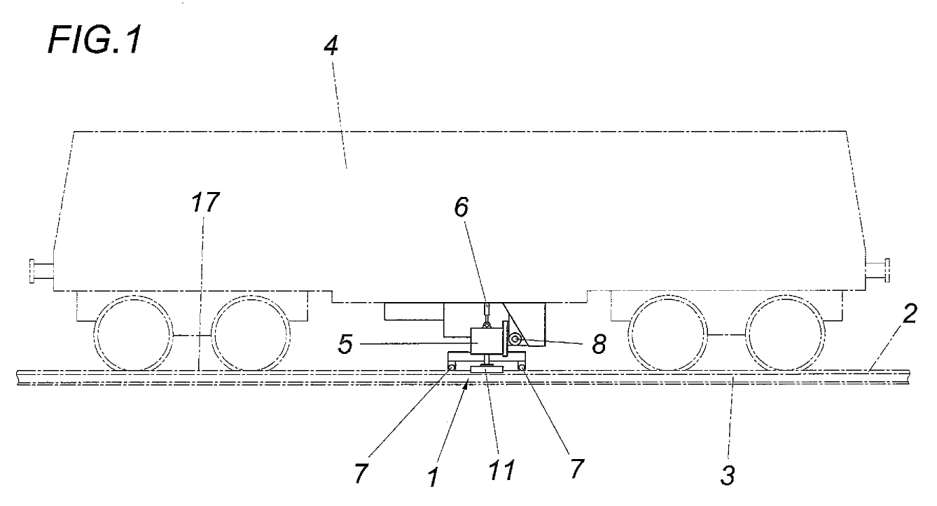

As can be inferred from FIG. 1, the device 1 according to the invention for reworking the rail head 2 of the rails 3 of a railway track by machining is arranged on a rail vehicle 4, with the aid of which the device 1 is moved along the rail 3. The device 1 has a framework 5 mounted on the rail vehicle 4, which is mounted so it is vertically adjustable with the aid of a lift drive 6 on the rail vehicle 4 and is supported via guide rollers 7 on the rail head 2. These guide rollers 7 not only guide the framework 5 vertically in relation to the rail 3, but rather also laterally.

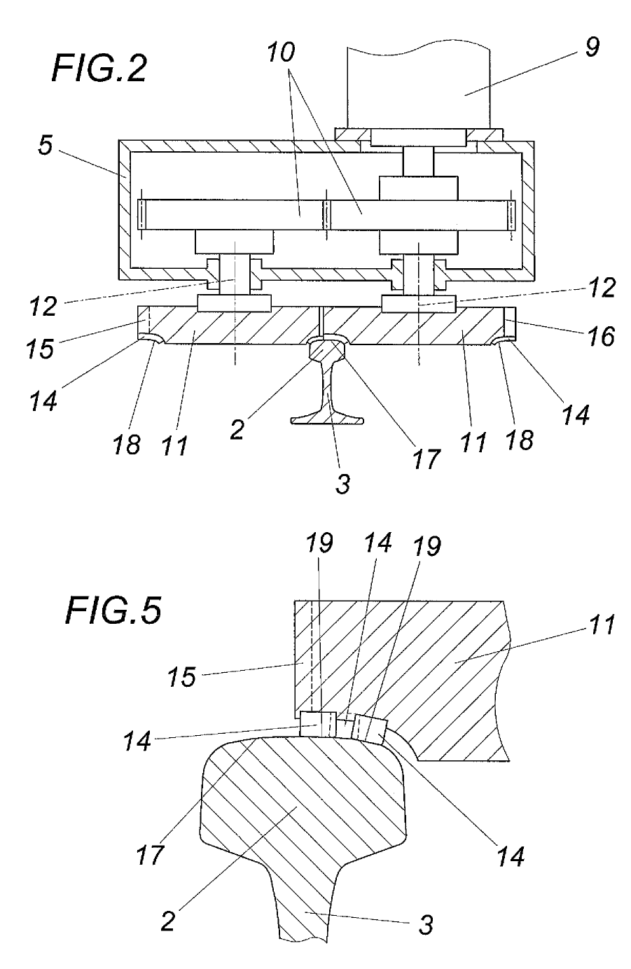

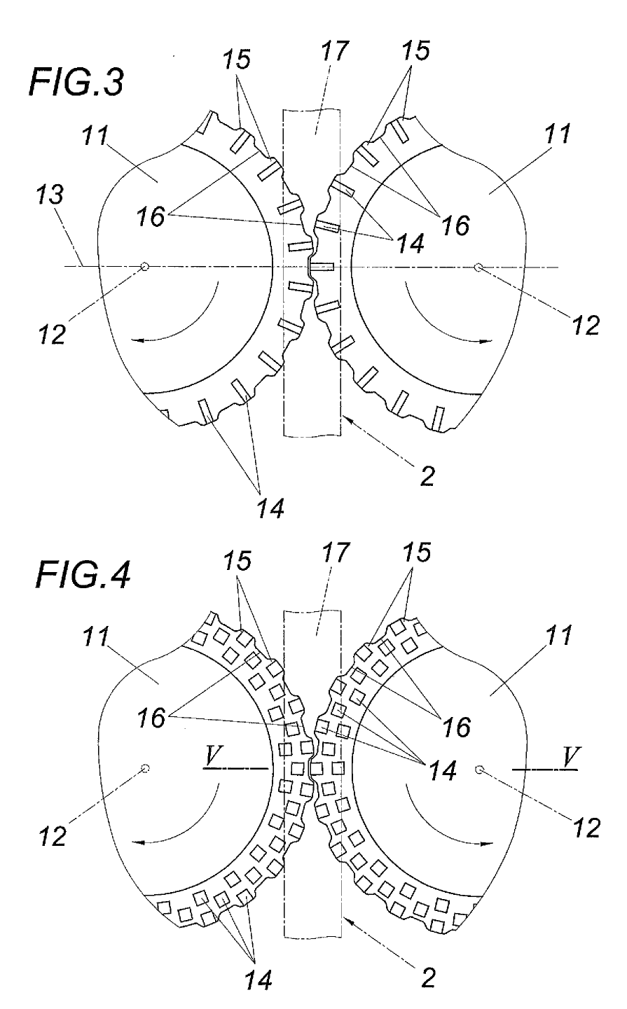

According to FIG. 2, the framework 5, which is linked for vertical displacement to the rail vehicle 4 via an axis 8, which is not required, however, receives a transfer case 10, which is connected to a rotational drive 9, for two machining tools drivable synchronously in opposite directions in the form of face millers 11. The rotational axes 12 of these face millers 11 are located in a common plane 13 perpendicular to the longitudinal direction of the rail head 2, as shown in FIG. 3. The arrangement is made so that the cutting areas of the two face millers 11, which are opposite in relation to the rail head 2, overlap. This is made possible in that the face millers 11 have radial attachments 15, which are distributed around the circumference and are provided with milling cutters 14, the attachments 15 of one face miller 11 being offset staggered in relation to the attachments 15 of the opposing face miller 11, so that if the two face millers 11 are driven in opposite directions, the radial attachments 15 respectively engage in the gaps 16 of the respective other face miller 11 resulting between these attachments 15, and with radial spacing to avoid friction and appearances of wear thus caused.

As is obvious from FIG. 2, the milling cutters 14 can have profile blades 18 adapted to the cross-sectional curve of the running surface 17 of the rail head 2, so that the running surface 17 can be reworked in accordance with the target profile predefined by the profile blade 19 of the milling cutter 14. Such precise reworking is generally not necessary, however. The running surface profile can therefore deviate from the target profile within a predefined tolerance range. This allows simpler design conditions using face millers 11, which have rings of face millers 14, which are radially offset to one another, having linear blades 19, as indicated in FIGS. 4 and 5. Via these linear blades 19 of the milling cutters 14, the target profile of the running surface 17 can be reproduced in the form of a traverse, the adaptation to the target profile of the running surface 17 being able to be refined with the number of the milling cutter rings. The reworking of the rail head 2 in the area of the track radius can—if necessary—be performed by milling cutters having corresponding profile blades.

Particularly advantageous working conditions result if at least two devices 1 are arranged in succession in the rail longitudinal direction on the rail vehicle 4 for both rails 3 of the railway track, in order to ensure uninterrupted reworking of the running surfaces 17 of the rails 3 if one device 1 must be taken out of operation for maintenance work, for example.

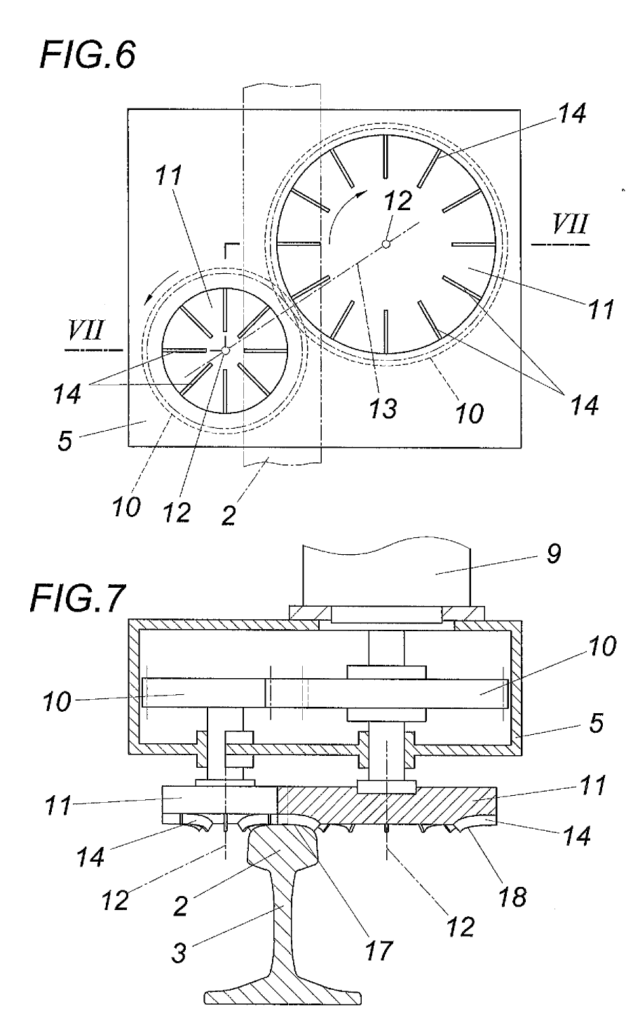

If the free space available for one face miller 11 is limited, for example, by a safety rail arranged on the curve inner side of a rail 3, a face miller 11 having a correspondingly small diameter must be used for the running surface machining of the rail head at least on the curve inner side, which results in difficulties with respect to the mounting of the face miller 11 in the framework 5. To provide a remedy here, according to FIGS. 6 and 7, the two face millers 11 can be mounted offset to one another in the framework 5 with respect to the longitudinal direction of the rail head 3, so that the spacing between the rotational axes 12 of the two face millers 11 is enlarged and space is thus provided for corresponding mounting of the face millers 11. The overlap of the two face millers 11 transversely to the longitudinal direction of the rail head 2 is maintained. Tooth-like intermeshing of the milling cutters 14 is not always necessary, however, so that in these cases, the attachments 15 of the face millers 11, which are otherwise necessary, can be omitted. Because of the comparatively small mutual offset of the cutting areas of the two face millers 11 in the longitudinal direction of the rail head 2, the machining errors occurring under certain circumstances due to this offset can be neglected. Both face millers 11 are jointly guided via the framework 5 in the manner described in conjunction with FIG. 1.

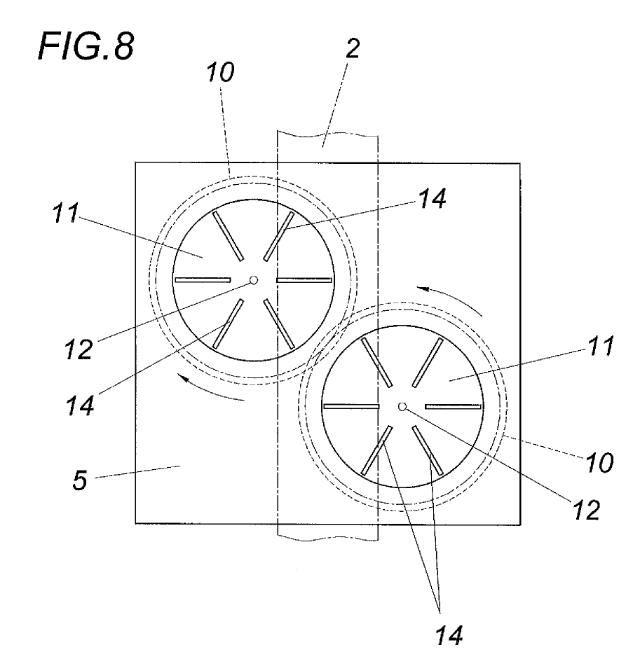

As may be seen from FIG. 8, it is also possible with a mutual offset of the two face millers 11 in the longitudinal direction of the rail head 2 to equip the face millers 11 on both sides of the rail head 2 with a small diameter, which becomes necessary, for example, if the free space for use of the face millers 11 is restricted on both sides of the rail head 2.

1. A device (1) for reworking the running surface (17) of a rail head (2) by machining, having a framework (5) guided along the rail head (2), in which two machining tools, which are drivable to rotate in opposite directions and can frontally approach the running surface (17), are mounted on both sides of the rail head (2), wherein the machining tools are designed as face millers (11), whose rotational axes (12) extend in a common plane (13) and whose cutting areas overlap one another transversely to the longitudinal direction of the rail head (2), and the two face millers (11) are connected via a transfer case (10) to a common rotational drive (9).

2. The device (1) according to claim 1, wherein the face millers (11) have radial attachments (15), which are distributed around the circumference and equipped with milling cutters (14), and which engage with radial spacing in the gaps,(16) between the staggered offset attachments (15) of the respective opposing face miller (11).

3. The device (1) according to claim 2, wherein the plane (13) of the rotational axes (12) of the face millers (11) extends perpendicularly to the longitudinal direction of the rail head (2).

4. The device (1) according to claim 1, wherein the milling cutters (14) of the face millers (11) have profile blades (18) adapted to the cross-sectional curve of the running surface (17).

5. The device (1) according to claim 1, wherein the face millers (11) have at least two rings, which are radially offset to one another, of milling cutters (14) having linear blades (19), which reproduce the cross-sectional curve of the running surface (17) in the form of a traverse.
